(19) United States
(12) Patent Application Publication
(10) Pub. No.: US 2026/0200340 A1
(43) Pub. Date: Jul. 16, 2026

(54) REDUCTION OF UNDESIRED ROTATIONAL WHEEL SPEED

(71) Applicant: VOLVO TRUCK CORPORATION, Göteborg (SE)

(72) Inventors: Alexander WÖLFINGER, Marstrand (SE); Björn GROTH, Göteborg (SE); Sidhant RAY, Mölndal (SE)

(73) Assignee: VOLVO TRUCK CORPORATION, Göteborg (SE)

(21) Appl. No.: 19/448,572

(22) Filed: Jan. 14, 2026

(30) Foreign Application Priority Data
Jan. 16, 2025 (EP) 25152241.3

(51) Int. Cl. B60L 15/20; B60L 7/10

(52) U.S. Cl. CPC B60L 15/2009; B60L 7/10; B60L 2240/423; B60L 2240/461; B60L 2240/463; B60L 2240/465; B60L 2240/48

(57) ABSTRACT

A computer system for reducing rotational speed of at least one wheel of a vehicle is described. The computer system has processing circuitry to determine a first value of rotational kinetic energy of one or more powertrain components of the vehicle, when the at least one wheel is rotating at a current rotational speed; acquire a second value of rotational kinetic energy of the one or more powertrain components, when the at least one wheel is rotating at a rotational speed where the wheel has a desired amount of slip; determine an energy difference between the first value of rotational kinetic energy and the second value of rotational kinetic energy; determine a first retardation torque pulse corresponding to the determined energy difference; and cause the determined first retardation torque pulse to be applied to at least one of the one or more powertrain components to reduce the rotational speed of the at least one wheel.

### TECHNICAL FIELD

The disclosure relates generally to vehicle motion management. In particular aspects, the disclosure relates to reduction of undesired rotational wheel speed. The disclosure can be applied to heavy-duty vehicles, such as trucks, buses, and construction equipment, among other vehicle types. In particular, the disclosure can be applied in electrical vehicles.

### BACKGROUND

When power is transmitted through a vehicle driveline and the torque applied to a wheel exceeds the traction force between the tyre and the road surface, the wheel will start to spin. This typically happens under conditions of low friction or when excessive power is delivered to the wheels, particularly during acceleration. Wheel spin results in loss of traction, reducing vehicle control and performance. Even if the vehicle has a quick response in the form of torque reduction, the wheels will keep spinning for some time due to the rotational energy of the wheels and driveline of the vehicle. The moment of inertia of these components will resist changes in their speed of rotation and delay the vehicle from regaining control and traction, particularly on low friction surfaces.

It is therefore desired to develop a solution for managing wheel spin that addresses or at least mitigates some of these issues.

### SUMMARY

This disclosure provides systems, methods and other approaches for reducing rotational speed of at least one wheel of a vehicle by determining the rotational kinetic energy of one or more components of a vehicle powertrain, both when the wheel is rotating at a current rotational speed and when the wheel is rotating at a rotational speed where the wheel has a desired amount of slip, for example a sufficiently low amount of slip. The difference in rotational kinetic energy when the wheel rotates at the two different speeds is then used to determine a corresponding retardation torque pulse. The retardation torque pulse is applied to at least one of the one or more powertrain components, such that the rotational speed of the at least one wheel is reduced. In this way, undesired rotational speed of a wheel may be counteracted in an efficient way, and a faster traction control response and reduced wheel spin is achieved.

According to a first aspect of the disclosure, there is provided a computer system for reducing rotational speed of at least one wheel of a vehicle, the computer system comprising processing circuitry configured to: determine a first value of rotational kinetic energy of one or more powertrain components of the vehicle when the at least one wheel is rotating at a current rotational speed; acquire a second value of rotational kinetic energy of the one or more powertrain components when the at least one wheel is rotating at a rotational speed where the wheel has a desired amount of slip; determine an energy difference between the first value of rotational kinetic energy and the second value of rotational kinetic energy; determine a first retardation torque pulse corresponding to the determined energy difference; and cause the determined first retardation torque pulse to be applied to at least one of the one or more powertrain components to reduce the rotational speed of the at least one wheel.

The first aspect of the disclosure may seek to provide a computer system for counteracting undesired rotational speed of a wheel, by determining the rotational kinetic energy caused by the undesired rotational speed and a corresponding retardation torque pulse. The system may then cause the determined retardation torque pulse to be applied to at least one powertrain component, such that the undesired rotational speed of the wheel is reduced. A technical benefit may include a faster traction control response and reduced wheel spin.

Optionally in some examples, including in at least one preferred example, the processing circuitry is configured to determine the first value of rotational kinetic energy based on a respective moment of inertia of the one or more powertrain components and a respective current rotational speed of the one or more powertrain components. A technical benefit may include that a robust and consistent way to determine rotational kinetic energy is achieved. As the values of moment of inertia are based on fixed properties of the powertrain components, such as their respective mass and geometry, only their current rotational speed needs to be measured in order to determine the first value of rotational kinetic energy. In this way, the need for complex and costly sensor systems is avoided and system complexity may be reduced.

Optionally in some examples, including in at least one preferred example, the second value of rotational kinetic energy is pre-determined based on a respective moment of inertia of the one or more powertrain components and a respective rotational speed of the one or more powertrain components, when the at least one wheel has a desired amount of slip. A technical benefit may include that faster traction control response is achieved, as the system is enabled to compare the current rotational kinetic energy against a known reference point for achieving a desired amount of slip, thereby reducing the time needed for complex calculations or processing.

Optionally in some examples, including in at least one preferred example, the first retardation torque pulse is a torque applied during a time t in a direction opposite to the direction of rotation of the one or more powertrain components. A technical benefit may include a controlled reduction in wheel speed, which quickly reduces excess rotational energy to regain traction without overcorrecting or causing unnecessary deceleration.

Optionally in some examples, including in at least one preferred example, the processing circuitry is configured to cause the first retardation torque pulse to be applied to at least one electric motor of the vehicle powertrain components. A technical benefit may include that an efficient and durable system for reducing rotational speed of at least one wheel is obtained, as controlling the at least one electric motor to reduce the power provided to the powertrain components enables immediate and precise modulation of torque without relying on mechanical components or introducing extra stress on the other components of the powertrain.

Optionally in some examples, including in at least one preferred example, the processing circuitry is further configured to control the at least one electric motor to convert the retardation torque pulse into electric energy and store the electric energy in a battery of the vehicle. A technical benefit may include that the energy of the retardation torque pulse is recovered, and the overall energy efficiency of the vehicle thereby improved.

Optionally in some examples, including in at least one preferred example, at least two wheels of the vehicle are controlled by one electric motor and the processing circuitry is configured to determine the first value of rotational kinetic energy for a wheel of the at least two wheels rotating with the highest rotational speed and to cause the determined first retardation torque pulse to be applied to the electric motor such that the rotational speed of each of the at least two wheels is reduced. A technical benefit may include that the retardation torque pulse is determined based on the fastest spinning wheel, such that it is assured that the rotational speed of all wheels is sufficiently reduced.

Optionally in some examples, including in at least one preferred example, the first and second value of rotational kinetic energy each further comprises the rotational kinetic energy of one or more of the one electric motor, an input shaft, a gearbox, an output shaft, a differential, and an axle shaft. A technical benefit may include that by including additional powertrain components in the calculations, a more accurate determination of the first and second value of rotational kinetic energy will be achieved, which will enable a more precise determination of the retardation torque pulse required to counteract undesired rotational speed.

Optionally in some examples, including in at least one preferred example, each wheel of the vehicle is controlled by a respective electric wheel motor and the processing circuitry is configured to determine a respective first value of rotational kinetic energy for each wheel, determine a respective energy difference between each first value of rotational kinetic energy and the second value of rotational kinetic energy, determine a respective first retardation torque pulse corresponding to each determined respective energy difference, and to cause a first respective retardation torque pulse to be applied to each respective wheel motor such that the rotational speed of each wheel is reduced individually. A technical benefit may include the provision of more precise traction control, allowing the system to determine a required retardation torque pulse for each wheel independently. In this way, torque is reduced only where necessary, without affecting the performance of other wheels.

Optionally in some examples, including in at least one preferred example, the first and second value of rotational kinetic energy each further comprises the rotational kinetic energy of the corresponding electric wheel motor. A technical benefit may include that, by including the electric wheel motor in the calculations, a more accurate determination of the first and second value of rotational kinetic energy will be achieved which will enable a more precise determination of the retardation torque pulse required to counteract undesired rotational speed.

Optionally in some examples, including in at least one preferred example, the processing circuitry is configured to determine the first retardation torque pulse in response to determining that the current rotational speed is above the rotational speed where the wheel has a desired amount of slip. A technical benefit may include the system the system is triggered to determine the first retardation torque pulse based on a condition, allowing the system to respond precisely when a wheel reaches a speed that indicates loss of traction. This ensures an efficient and targeted response, with improved vehicle stability during dynamic driving conditions.

Optionally in some examples, including in at least one preferred example, the processing circuitry is further configured to determine a second retardation torque pulse to further reduce the wheel speed to the rotational speed where the wheel has the desired amount of slip, in response to determining that the rotational speed of the at least one wheel is above the rotational speed where the wheel has the desired amount of slip after the first retardation torque pulse has been applied. A technical benefit may include that a system which continuously monitors the rotational speed of the wheel is provided, allowing the retardation torque applied to be incrementally increased. In this way, the system prevents over-braking while effectively managing persistent wheel spin if the first retardation torque pulse was not sufficient to regain traction.

According to a second aspect of the disclosure, there is provided a vehicle comprising the computer system of any preceding aspect. The second aspect of the disclosure may seek to provide a vehicle capable of determining the energy required to counteract undesired rotational speed of at least one wheel of the vehicle and applying a corresponding retardation torque pulse to at least one powertrain component. Thereby, the undesired rotational speed of the at least one wheel is reduced. A technical benefit may include a vehicle with faster traction control response and reduced wheel spin, and thus increased safety and stability.

According to a third aspect of the disclosure, there is provided a computer-implemented method for reducing rotational speed of at least one wheel of a vehicle, the method comprising: determining, by processing circuitry of a computer system, a first value of rotational kinetic energy of one or more powertrain components, of the vehicle when the at least one wheel is rotating at a current rotational speed; acquiring, by the processing circuitry, a second value of rotational kinetic energy of the one or more powertrain components, when the at least one wheel is rotating at a rotational speed where the wheel has a desired amount of slip; determining, by the processing circuitry, an energy difference between the first value of rotational kinetic energy and the second value of rotational kinetic energy; determining, by the processing circuitry a first retardation torque pulse corresponding to the determined energy difference; and causing, by the processing circuitry, the determined first retardation torque pulse to be applied to at least one of the one or more powertrain components to reduce the rotational speed of the at least one wheel.

The third aspect of the disclosure may seek to provide a computer-implemented method for determining the energy required to counteract undesired rotational speed of at least one wheel of a vehicle and applying a retardation torque pulse corresponding to the determined energy to at least one powertrain component of the vehicle. Thereby, the undesired rotational speed of the at least one wheel is reduced in an efficient way. A technical benefit may include a faster traction control response and reduced wheel spin.

According to a fourth aspect of the disclosure, there is provided a computer program product comprising program code for performing, when executed by the processing circuitry, the computer-implemented method. The fourth aspect of the disclosure may seek to enable new vehicles and/or legacy vehicles to be conveniently configured, by software installation/update, to determine the energy required to counteract undesired rotational speed of at least one wheel of the vehicle and apply a corresponding retardation torque pulse to at least one powertrain component of the vehicle. A technical benefit may include a faster traction control response and reduced wheel spin.

According to a fifth aspect of the disclosure, there is provided a non-transitory computer-readable storage medium comprising instructions, which when executed by the processing circuitry, cause the processing circuitry to perform the computer-implemented method. The fifth aspect of the disclosure may seek to enable new vehicles and/or legacy vehicles to be conveniently configured, by software installation/update, to determine the energy required to counteract undesired rotational speed of at least one wheel of the vehicle and apply a corresponding retardation torque pulse to at least one powertrain component of the vehicle. A technical benefit may include a faster traction control response and reduced wheel spin.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 schematically shows a side view of a vehicle according to an example.

FIG. 2 schematically shows a powertrain of a vehicle according to an example.

FIG. 3 schematically shows a powertrain of a vehicle according to a second example.

FIG. 4 is a flow chart of a computer-implemented method according to an example.

FIG. 5 is a schematic diagram of a computer system for implementing examples disclosed herein.

Like reference numerals refer to like elements throughout the description.

### DETAILED DESCRIPTION

The detailed description set forth below provides information and examples of the disclosed technology with sufficient detail to enable those skilled in the art to practice the disclosure.

Wheel spin occurs when the torque applied to a vehicle wheel exceeds the available traction. Wheel spin may lead to loss of vehicle control, reduced vehicle stability, and increased tyre wear. Therefore, when wheel spin occurs, it is important to regain traction as quickly as possible. However, even if the vehicle has a quick response in torque reduction, the wheels will keep spinning for some time due to the rotational kinetic energy of the components of the vehicle powertrain, which will continue to drive the wheels forward. The wheels will not stop spinning until enough energy to counteract this rotational kinetic energy has been accumulated by tyre friction. On a low friction surface, this may take some time.

To remedy this, systems and methods are proposed for determining the energy required to counteract undesired rotation of a wheel. In particular, systems and methods are proposed for determining a difference between the rotational kinetic energy of one or more powertrain components when the wheel is rotating at a current, undesired rotational speed, and the rotational kinetic energy of the one or more powertrain components when the wheel is rotating at a desired rotational speed. Based on this, a retardation torque pulse can be determined and applied to components of the vehicle powertrain, such that the undesired rotational speed of the wheel is reduced. In this way, faster traction control and reduced wheel spin is achieved in an efficient way.

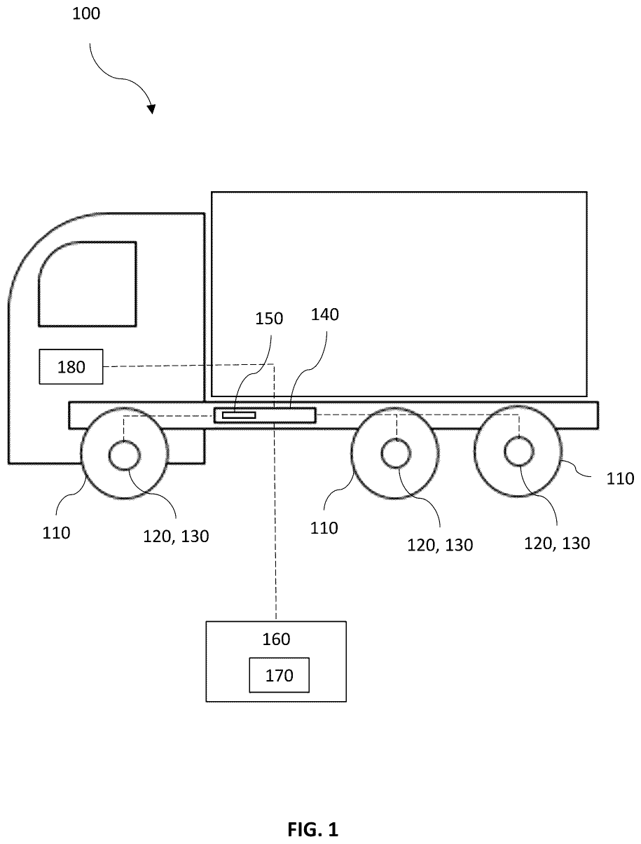

FIG. 1 schematically shows a side view of an example vehicle 100 of the type considered in this disclosure. The vehicle 100 may be any suitable form of vehicle. For example, the disclosure can be applied in heavy-duty vehicles, such as trucks, buses, construction equipment, and multi-unit vehicle combinations, in personal vehicles such as cars, vans, or motorbikes, or in any other suitable form of vehicle. The vehicle 100 comprises a number of axles, each generally having two or more wheels 110. Whilst three axles are shown, it will be appreciated that any suitable number of axles may be provided. It will also be appreciated that any number of the axles may be driven axles. The vehicle 100 normally comprises a steered axle, or more than one steered axle.

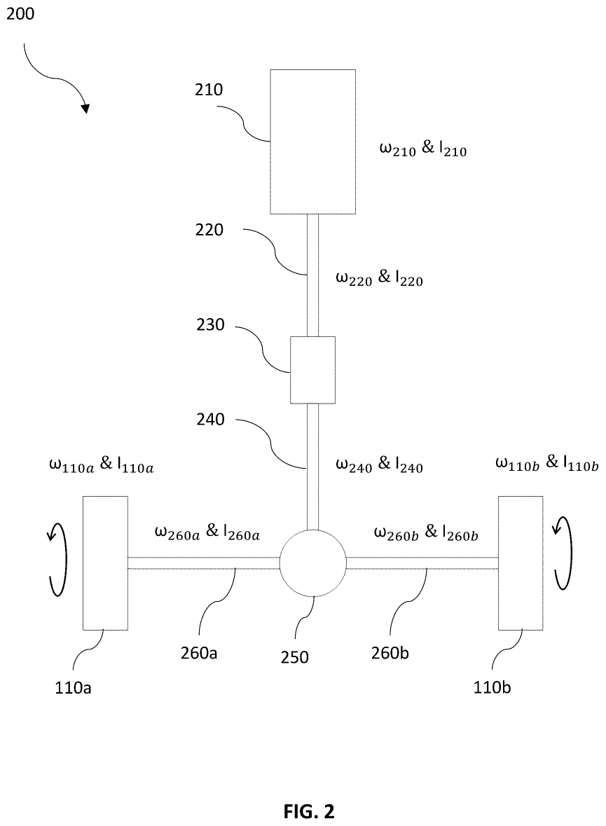

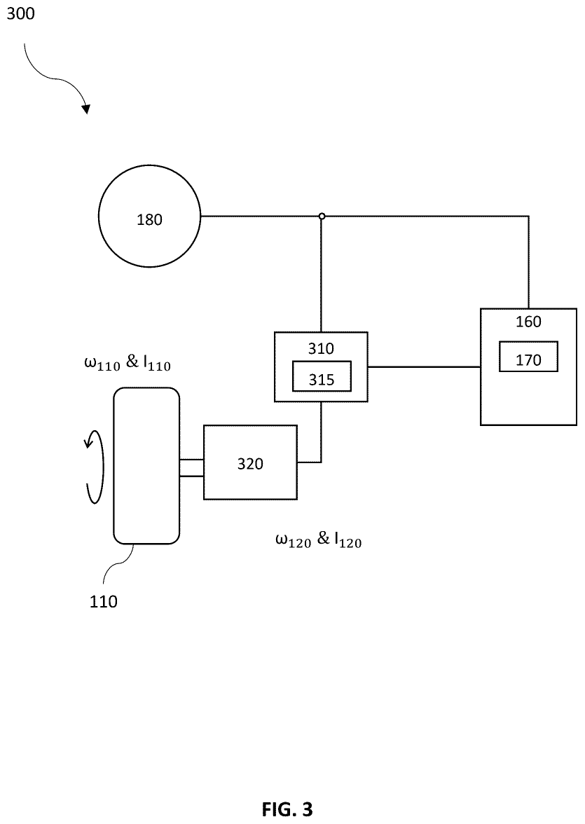

The vehicle 100 may comprise one or more sources of propulsion. For example, the vehicle 100 may comprise one or more electrical machines 120 such as electric motors and/or generators. The vehicle 100 may comprise one or more batteries (not shown) configured to provide power to the electrical machines 120. In some examples, the vehicle 100 may also include another source of propulsion, for example an internal combustion engine (ICE). The vehicle 100 also comprises a powertrain (not shown) configured to deliver mechanical power from the propulsion source (the electrical machines 120 or the ICE) to the wheels 110. The vehicle powertrain will be discussed further in relation to FIGS. 2 and 3.

The electrical machines 120 are configured to drive, e.g. provide torque and/or steering to, one or more axles or individual wheels 110 of the vehicle 100. The electrical machines 120 can supply either a positive (propulsion) or negative (braking) force. The use of electrical machines 120 to supply a negative force is known as regenerative braking. When regenerative braking is engaged, the operation of the electrical machine 120 is reversed by a control unit, which causes the electrical machine 120 to operate as a generator. Instead of consuming electrical energy to drive the wheels, the motor converts the kinetic energy of the vehicle into electrical energy, which may be stored in a battery.

Furthermore, the vehicle 100 may comprise one or more sets of service brakes 130. The service brakes 130 can supply a negative (braking) force. The service brakes 130 may be, for example, frictional brakes such as pneumatic brakes. Pneumatic brakes use a compressor to fill the brake with air, which may be powered by the batteries. In some examples, the brakes may be electro-mechanical brakes. The energy recovered from regenerative braking by the electrical machines 120 can be stored in the batteries, and so regenerative braking by the electrical machines 120 may be generally preferred over using the service brakes 130. The electrical machines 120, service brakes 130, and ICE of a vehicle 100 may be referred to as actuators or motion support devices (MSDs) of the vehicle 100.

In some examples, the vehicle 100 may be a vehicle combination comprising a number of units, including a tractor unit and at least one trailing unit. A tractor unit is generally the foremost unit in a vehicle combination, and may comprise the cabin for the driver, including steering controls, dashboard displays and the like. Generally, the tractor unit is used to provide propulsion power for the vehicle combination 100. A trailing unit is generally used to store goods that are being transported by the vehicle combination 100. A trailing unit may be a truck, trailer, dolly and the like. A trailing unit may also provide propulsion to the vehicle combination 100. In such examples, each unit may comprise its own electrical machines 120, batteries, service brakes 130, and the like. In this way, all units may provide propulsion to the vehicle combination 100.

The vehicle 100 further includes a controller 140 comprising processing circuitry 150. The controller 140 is configured to control components of the vehicle, for example the electrical machines 120. FIG. 1 shows a common controller 140 for all electrical machines 120 of the vehicle 100, however it will be appreciated that each electrical machine 120 may have its own respective controller. In many cases, the controller 140 may be implemented in the structure of the electrical machine 120 itself. The controller 140 may be a microcontroller. In examples where the vehicle 100 is a vehicle combination, the vehicle 100 may include a global controller and a plurality of unit controllers, for example a controller for each unit. Vehicle motion management may therefore be available on a unit level to receive requests from a manual or virtual driver to coordinate the propulsion, braking and steering.

The controller 140 may receive control signals from a global controller 160 comprising processing circuitry 170. The global controller 160 may be a vehicle control unit configured to perform various vehicle (unit) control functions, such as vehicle motion management. The global controller 160 may be local to the vehicle 100, for example implanted in a controller 140, or may be a remote system, implemented at a distance from the vehicle 100. The global controller 160 may be communicatively coupled to the controller 140 in any suitable way, for example via a circuit or any other wired, wireless, or network connection known in the art. Furthermore, the communicative coupling may be implemented as a direct connection between the controller 140 and the global controller 160, or may be implemented as a connection via one or more intermediate entities. One function of the controller 140 and the global controller 160 is to provide control inputs for the vehicle 100, for example torque, force, or slip requests.

The controllers 140, 160 of the vehicle 100 may further be connected to a sensor system 180 configured to provide input to the controllers 140, 160 relating to real-time operating conditions of the vehicle 100, such that the controllers 140, 160 may adjust the operation of the vehicle 100 accordingly. The sensor system 180 will be discussed in more detail in relation to FIG. 3.

FIG. 2 schematically shows a powertrain 200 of the vehicle 100 according to a first example. The powertrain 200 comprises an electric motor 210 configured to deliver mechanical power to at least two wheels 110a, 110b of the vehicle 100. The powertrain 200 further comprises an input shaft 220, a gearbox 230, an output shaft 240, a differential 250, and an axle shaft 260 comprising a left half shaft 260a and a right half shaft 260b, connecting the electric motor 210 to respective ones of the at least two wheels 110a, 110b. Depending on whether the vehicle has a front-wheel or rear-wheel drive configuration, the electric motor 210 is configured to deliver power to the wheels on either the front or the rear axle. In all-wheel-drive configurations, the electric motor 210 is configured to deliver power to the wheels on both the front axle shaft and the rear axle.

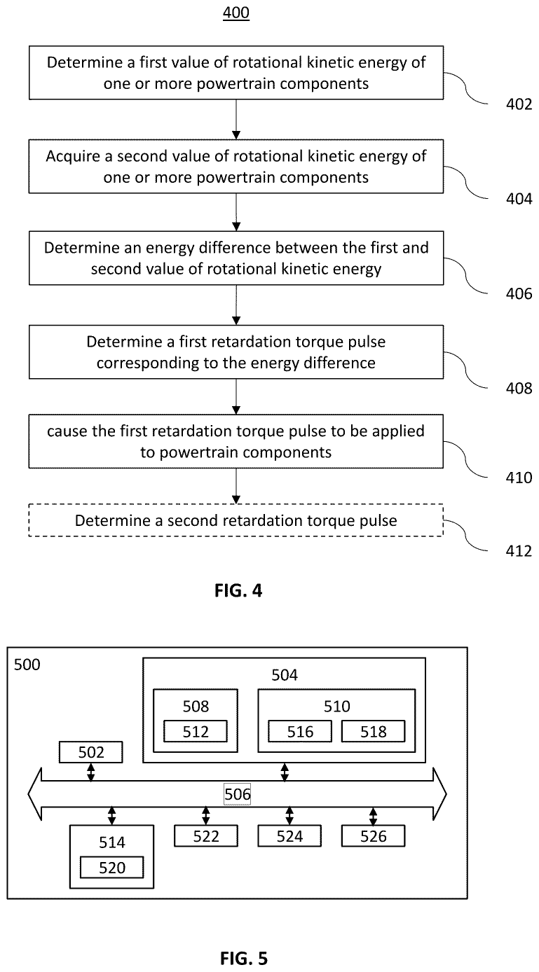

The electric motor 210 may correspond to an electrical machine 120 discussed in relation to FIG. 1. It is typically positioned centrally in the vehicle 100 and configured to convert electrical energy stored in a battery into mechanical energy, thereby generating rotational torque. The speed and torque output of the electric motor 210 are controlled by a control unit, for example the controller 140. When set in motion, the rotational speed of the electric motor 210 is ω₂₁₀. The moment of inertia of the electric motor 210 is I₂₁₀. The impact of the rotational speed and the moment of inertia of the different powertrain components in reducing undesired rotation speed of the at least one wheel will be discussed below and in relation to FIG. 4.

An output of the electric motor 210 is connected to an input of the gearbox 230 through input shaft 220. In this way, the input shaft 220 is configured to transmit rotational power from the electric motor 210 to the gearbox 230. When set in motion, the rotational speed of the input shaft 220 is ω₂₂₀. The moment of inertia of the input shaft 220 is I₂₂₀.

The gearbox 230 comprises a set of gears configured to alter the rotational speed and torque of the input shaft 220 depending on the driving conditions of the vehicle, and to transfer power to an output shaft 240. The rotational speed of the gearbox 230 is ω₂₃₀. The moment of inertia of the gearbox 230 is I₂₃₀.

The output shaft 240 is configured to receive the adjusted torque and rotational speed from the gearbox 230, and to transmit it to the differential 250. When set in motion, the rotational speed of the output shaft 240 is ω₂₄₀. The moment of inertia of the output shaft 240 is I₂₄₀.

The differential 250 and the axle shaft 260 provide the final link in the powertrain 200. The differential 250 is configured to split the power transferred from the output shaft 240 to the left and right half shafts 260a, 260b of the front and/or rear axles, and enables the half shafts 260a, 260b to rotate at different speeds. The rotational speed of the differential 250 is ω₂₅₀. The moment of inertia of the differential 250 is I₂₅₀. The respective rotational speeds of the half shafts 260a, 260b are ω₂₆₀ₐ, ω_{260b}. The respective moments of inertia of the half shafts 260a, 260b are I₂₆₀ₐ, I_{260b}.

The half shafts 260a, 260b then transfer power from the differential 250 to a respective wheel 110a, 110b, enabling the vehicle to move. When set in motion, the respective rotational speeds of the wheels 110a, 110b are ω₁₁₀ₐ, ω_{110b}. The respective moments of inertia of the wheels 110a, 110b are I₁₁₀ₐ, I_{110b}.

Though not shown, the electric motor 210 in the powertrain 200 may be controlled by the controller 140, which receives control signals from the global controller 160, as discussed in relation to FIG. 1. For example, the controller 140 may receive a torque request from the global controller 160, whereby the electric motor 210 is controlled to generate power which is then transferred through the components of the powertrain 200 and to the wheels 110a, 110b.

FIG. 3 schematically shows a powertrain 300 of the vehicle 100 according to a second example. The powertrain 300 comprises a respective electric wheel motor 320 arranged at each wheel 110, configured to deliver power to the respective wheel 110. In FIG. 3, only a single wheel 110 is shown, although it will be appreciated that each of multiple wheels 110 of the vehicle 100 may have a respective electric wheel motor 320. The electric wheel motor 320 of powertrain 300 may correspond to the electrical machine 120 discussed in relation to FIG. 1.

The electric wheel motor 320 is attached directly to or integrated into a respective wheel hub and configured to provide propulsion directly to its respective wheel 110. Therefore, the need for powertrain components configured to transfer power from the motor to the wheels 110, as discussed in relation to FIG. 2, is eliminated. When set in motion, the rotational speed of the respective electric wheel motor 320 is ω₁₂₀. The moment of inertia of the respective electric wheel motor 320 is I₁₂₀. When set in motion, the rotational speed of the respective wheel 110 is ω₁₁₀. The moment of inertia of the respective wheel 110 is I₁₁₀.

Each electric wheel motor 320 may be controlled by a respective controller 310, comprising processing circuitry 315. The controller 310 may correspond to controller 140 discussed in relation to FIG. 1 and allows each electric wheel motor 320 to be independently controlled. The independent control enables precise distribution of power to each wheel 110 based on real-time conditions. For example, during a turn, the outer wheels can be given more power than the inner wheels, improving cornering efficiency. The power distribution may also be adjusted for each wheel based on the traction available, such that the power transmitted to a spinning wheel is reduced while maintaining optimal speed of other wheels.

In both FIG. 2 and FIG. 3, the individual control of each electric motor 210, 320 may be coordinated by a centralized control system, for example the global controller 160 comprising processing circuitry 170. The global controller 160 determines the optimal torque and speed for each electric motor 210, 320, and may determine a corresponding control signal for each controller 310, such that performance, stability and maneuverability of the vehicle 100 is ensured.

As discussed in relation to FIG. 1, the controllers 140, 160, 310 of the vehicle 100 may be connected to a sensor system 180 configured to provide input to the controllers 140, 160, 310 relating to real-time operating conditions of the vehicle 100. In FIG. 3, the sensor system 180 is shown as part of powertrain 300 and connected to controller 310. Here, the sensor system 180 is configured to provide sensor data relating to the powertrain 300, for example the current rotational speed ω₁ᵢ of the respective wheel 110 and optionally the respective electric wheel motor 320. In a vehicle 100 comprising a powertrain 200 according to FIG. 2, though not shown in FIG. 2, the sensor system 180 is connected to controllers 140, 160, 310 and configured to provide sensor data relating to the powertrain 200, for example the current rotational speed ω₁ᵢ of the wheels 110a, 110b and optionally powertrain components 210, 220, 230, 240, 250, 260.

When an electric machine 120, 210, 320 of the powertrain 200, 300 is controlled to distribute power to at least one wheel 110 of the vehicle 100, as discussed above, each component of the powertrain 200, 300 will begin to rotate, and the vehicle 100 will be set in motion. The rotational motion of the powertrain components will cause the components to gain a rotational kinetic energy Eᵢ. The rotational kinetic energy Eᵢ of each component depends on the rotational speed ω₁ᵢ and the moment of inertia Iᵢ of the respective component i, see equation (1).

$${E}_{i} = \frac{{I}_{i} {ω}_{i}^{2}}{2} \qquad ( 1 )$$

Here, Eᵢ is the rotational kinetic energy, Iᵢ is the moment of inertia, and ωᵢ is the rotational speed of component i.

Moment of inertia is the tendency of an object to resist changes in its state of rotation. Thus, once the components of the vehicle powertrain 200, 300 are set in motion, their moment of inertia will work to keep them rotating even when the power provided by the electrical machine 120, 210, 320 to the powertrain 200, 300 is reduced or stopped. To slow or stop the rotational motion of the powertrain components, their rotational kinetic energy must be counteracted, either through friction or braking. Especially on low friction surfaces, it will take some time before enough energy has been accumulated through friction to counteract the rotational kinetic energy due to moment of inertia in the powertrain.

Moment of inertia depends on both the mass of the object and how that mass is distributed relative to the axis of rotation. Heavier or more widely distributed mass means the object will have a larger moment of inertia, making it more resistant to changes in its rotational speed. For example, the wheels 110 of the vehicle will have a relatively high moment of inertia I₁₁₀ as they are relatively heavy and have a large radius with the mass distributed around the circumference of the wheel. In comparison, input shaft 220 and output shaft 240, for example, will have a lower moment of inertia, I₂₂₀ and I₂₄₀, as they have a smaller radius with mass distributed closer to the axis of rotation.

A quick response in reducing undesired rotational motion is particularly important for traction control, in order to maintain vehicle stability and prevent wheel spin. Wheel spin occurs when the power transmitted through a powertrain 200, 300 and the torque applied to the wheels 110 exceeds the traction force between the tyre of the wheel 110 and the road surface. As a result, the wheel 110 will start to spin. Wheel spin results in loss of traction, reducing vehicle control and performance.

To remedy this, systems and methods are proposed for determining and applying the energy required to counteract undesired rotational speed of at least one wheel of a vehicle.

FIG. 4 is a flow chart of a computer-implemented method 400 for reducing undesired rotational speed of at least one wheel 110 of a vehicle 100, according to an example. The method 400 determines the energy required to counteract the rotational speed caused by moment of inertia of one or more powertrain components. The method 400 enables a retardation torque pulse corresponding to the determined energy to be applied to components of the powertrain. In this way, the rotational speed of the at least one vehicle wheel is efficiently reduced, and a faster traction control response and reduced wheel spin are obtained. The method 400 may be implemented by processing circuitry of a computer system (e.g., the processing circuitry 150 of the controller 140, the processing circuitry 170 of the global controller 160 described in relation to FIG. 1, or the processing circuitry 315 of the controller 310 described in relation to FIG. 3).

At 402, a first value of rotational kinetic energy E₁ of one or more powertrain components 110, 120, 210, 220, 230, 240, 250, 260, 320 of the vehicle 100 is determined when the at least one wheel 110 is rotating at a current rotational speed ω₁. The rotational kinetic energy may be determined using any known configuration of sensors for determining rotational kinetic energy. In one example, the determination of the first value of rotational kinetic energy E₁ is based on the moment of inertia I₁₁₀ and the current rotational speed ω₁₁₀ of the at least one wheel 110. In a preferred example, the first value of rotational kinetic energy E₁ is determined using equation (1) discussed above.

For increased accuracy, one or more powertrain components 120, 210, 220, 230, 240, 250, 260, 320 in addition to the at least one wheel 110 are included in the determination of E₁. In one example, the first value of rotational kinetic energy E₁ is based on a respective moment of inertia I; and a respective rotational speed ωᵢ of each of the powertrain components involved in transferring power from an electrical machine 120, 210, 320 to the at least one wheel 110. In a powertrain 200 according to FIG. 2, each of the powertrain components 110, 120, 210, 220, 230, 240, 250, 260, 320 may be included in the determination of the first value of rotational kinetic energy E₁. In a powertrain 300 according to FIG. 3, each of the powertrain components 110, 320 may be included in the determination of the first value of rotational kinetic energy E₁.

The respective moment of inertia Iᵢ of the powertrain components may be determined using any known method to determine moment of inertia. For example, it may be calculated using equation (2) below.

$${I}_{i} = \sum {m}_{i} {r}_{i}^{2} \qquad ( 2 )$$

Here, mᵢ represents the mass of each element of a component, and rᵢ represents the distance from the axis of rotation of each element of a component. The values of moment of inertia may also be derived from CAD models of the powertrain components, based on the geometry and material properties of each component. This may be particularly beneficial for components with a complex geometry where the mass is distributed in a non-uniform manner.

The current rotational speed ω₁ᵢ of the one or more powertrain components may be measured using sensor system 180. The sensor system 180 is communicatively connected to the controllers 140, 160, 310 of the powertrain 200 and the powertrain 300, and continuously monitors the rotational speed ω₁₁₀ of the at least one wheel 110 of the vehicle powertrain 200, 300. When one or more additional powertrain components are included in the determination of E₁, the sensor system 180 may monitor each of the rotational speed ω₂₁₀ of the electric motor 210, the rotational speed ω₂₂₀ of the input shaft 220, the rotational speed ω₂₃₀ of the gearbox 230, the rotational speed ω₂₄₀ of the output shaft 240, the rotational speed ω₂₅₀ of the differential 250 and/or the rotational speed ω₂₆₀ of the axle shaft 260 of powertrain 200, and the rotational speed ω₁₂₀ of the electric wheel motor 120 of powertrain 300.

At 404, a second value of rotational kinetic energy E₂ of the one or more powertrain components 110, 120, 210, 220, 230, 240, 250, 260, 320 is acquired, when the at least one wheel 110 is rotating at a rotational speed ω₂ where the wheel has traction (or is considered to have sufficient traction). The rotational speed ω₂ can be considered as a rotational speed at which the wheel has a desired amount of slip, for example a sufficiently low but non-zero slip. The rotational speed may be estimated by monitoring data from wheel speed sensors and determining the wheel slip ratio, i.e. the difference between the rotational speed of the at least one wheel 110 speed and the actual vehicle speed. When this slip ratio rises too high, there is a risk of wheel spin. An example value of a desired slip may be 2%, although it will be appreciated that the skilled person may select any desired slip value or range based on implementation and operational conditions. This may be implemented by the skilled person using any suitable slip-speed relation or approach known in the art. The rotational speed ω₂ can be considered as a rotational speed where the driven wheel is behaving in the same or similar manner as a free rolling wheel, e.g. the rotational wheel speeds are the same. In some examples, this can be identified when the rotational speed of the driven wheel is within a margin of a modelled or measured rotational speed of a free rolling wheel under the same conditions, for example within ±1%. The rotational speed ω₂ where the at least one wheel 110 has traction and/or a desired amount of slip may be considered as a threshold rotational speed. The threshold rotational speed is influenced by the vehicle's torque output, road surface friction, tire characteristics, and vehicle weight distribution, as will be known by the person skilled in the art. The threshold rotational speed may be set lower on slippery surfaces like wet or icy roads and higher on dry, high-friction surfaces.

As the moment of inertia of the respective powertrain components and the threshold rotational speed is known, the second value of rotational kinetic energy E₂ may be predetermined, using equation (1) discussed above. In this way, the time needed for complex calculations is reduced. The threshold rotational speed may function as a trigger, such that method steps for reducing undesired rotational speed are performed in response to determining that the current rotational speed is above the threshold rotational speed.

At 406, an energy difference ΔE between the first value of rotational kinetic energy E₁ and the second value of rotational kinetic energy E₂ is determined, i.e. the difference in rotational kinetic energy when the at least one wheel 110 is rotating at the current rotational speed and at the rotational speed ω₂ where the wheel 110 has traction and/or a desired amount of slip. Consequently, the energy difference ΔE represents the energy required to counteract undesired rotational speed of the at least one wheel 110 and provide traction to the wheel 110. The energy difference ΔE may be determined by equation (3) below.

$$Δ E = {E}_{1} - {E}_{2} = {\sum }_{i = 1}^{n} \frac{{I}_{i} ( {ω}_{1 i}^{2} - {ω}_{2 i}^{2} )}{2} \qquad ( 3 )$$

Here, ω₁ᵢ is the respective rotational speed of the powertrain components at the current rotational speed of the wheel 110, ω₂ᵢ is the respective rotational speed of the powertrain components at the rotational speed ω₂ of the wheel 110, and n is the number of components in the powertrain.

At 408, a first retardation torque pulse corresponding to the determined energy difference ΔE is determined. The first retardation torque pulse is a torque applied during a time t in a direction opposite to the direction of rotation of the one or more powertrain components. It may be determined according to equation (4) below.

$$Δ E = \frac{T q}{t} \qquad ( 4 )$$

As discussed, ΔE represents the energy required to counteract undesired rotational speed of the at least one wheel 110, Tq is the first retardation torque pulse and t is the time during which the retardation torque is applied. By applying the retardation torque as a pulse during a time t, the reduction in rotational wheel speed is performed in a controlled manner.

The time t is determined based on a desired frequency and amplitude of the retardation torque pulse. The frequency may be set at a constant value, based on factors such as the motor's response time and the resonant frequency of the powertrain components, to ensure that undesired resonance effects are avoided. Similarly, the amplitude may also be set at a constant value, based on an upper limit to ensure that the applied torque does not exceed structural or operational limits of the powertrain components. Consequently, by knowing the desired frequency and amplitude of the retardation torque pulse along with the energy (ΔE) which needs to be dissipated, the time t can be calculated.

In a powertrain 200 wherein at least two wheels 110a, 110b are controlled by one electric motor 210, the first value of rotational kinetic energy E₁, the energy difference ΔE, and the first retardation torque pulse are determined for the wheel of the at least two wheels rotating with the highest rotational speed. In a powertrain 300 wherein at each wheel 110 is controlled by a respective electric wheel motor 320, a first value of rotational kinetic energy E₁, an energy difference ΔE, and a corresponding first retardation torque pulse is determined for each wheel rotating with a rotational speed above the threshold rotational speed independently.

At 410, the controllers 140, 160, 310 cause the determined first retardation torque pulse to be applied to at least one of the one or more powertrain components to reduce the rotational speed of the at least one wheel. According to one example, the first retardation torque pulse is applied to at least one electric motor 120, 210, 320 of the powertrain 200, 300. Thereby, the at least one electric motor 120, 210, 320 may further be controlled to convert the first retardation torque pulse into electric energy and store it in a battery of the vehicle. According to one example, the first retardation torque pulse is applied with a driveline retarder or any other device that can effectively send negative torque to the wheel of a vehicle powertrain.

In a powertrain 200 wherein at least two wheels 110a, 110b are controlled by one electric motor 210, the determined first retardation torque pulse is applied to the electric motor 210 such that the rotational speed of each of the at least two wheels 110a, 110b is reduced. By provision of the differential 250, the retardation torque pulse will be split between the at least two wheels 110a, 110b based on the relative motion between the wheels. In this way, the speed of the wheel of the at least two wheels rotating with the highest rotational speed will be reduced such that the wheel stops spinning, while the speed reduction of the other wheels of the at least two wheels will be minimal. In a powertrain 300 wherein each wheel 110 is controlled by a respective electric wheel motor 320, the determined first retardation torque pulse is applied to the respective wheel motor 320 such that the rotational speed of each wheel 110 is reduced individually.

In some examples, at 412, the method further includes determining a second retardation torque pulse to further reduce the rotational wheel speed to the rotational speed ω₂ where the wheel 110 has traction and/or a desired amount of slip, in response to determining that the rotational speed of the at least one wheel 110 is above the rotational speed ω₂ after the first retardation torque pulse has been applied. That is to say, in the case that the first retardation torque pulse does not provide sufficient retardation to provide traction at the wheel 110, a second retardation torque pulse can be determined and applied. The second retardation torque pulse is determined by updating the first value of rotational kinetic energy E₁ to a current value of rotational kinetic energy, when the at least one wheel 110 is rotating at the rotational speed after the first retardation torque pulse has been applied. A new energy difference ΔE is determined based on the current value of rotational kinetic energy and the second value of rotational kinetic energy E₂, and the second retardation torque pulse is determined based on the new energy difference ΔE.

By continuously monitoring the rotational speed of the wheels 110 using sensor system 180, the retardation torque pulse applied may be incrementally increased as needed. In this way, the system prevents over-braking while effectively managing persistent slip if the first retardation torque pulse was not sufficient to regain traction.

The method 400 enables the energy required to counteract undesired rotational speed of at least one wheel due to moment of inertia of the powertrain components to be determined, and a corresponding retardation torque pulse to be applied to at least one powertrain component, such that the undesired rotational speed is reduced in an efficient way. In this way, faster traction control response and reduced wheel spin is achieved.

FIG. 5 is a schematic diagram of a computer system 500 for implementing examples disclosed herein. The computer system 500 is adapted to execute instructions from a computer-readable medium to perform these and/or any of the functions or processing described herein. The computer system 500 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 500 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 500 may comprise at least one computing device or electronic device capable of including firmware, hardware, and/or executing software instructions to implement the functionality described herein. The computer system 500 may include processing circuitry 502 (e.g., processing circuitry including one or more processor devices or control units), a memory 504, and a system bus 506. The computer system 500 may include at least one computing device having the processing circuitry 502. The system bus 506 provides an interface for system components including, but not limited to, the memory 504 and the processing circuitry 502. The processing circuitry 502 may include any number of hardware components for conducting data or signal processing or for executing computer code stored in memory 504. The processing circuitry 502 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 502 may further include computer executable code that controls operation of the programmable device.

The system bus 506 may be any of several types of bus structures that may further interconnect to a memory bus (with or without a memory controller), a peripheral bus, and/or a local bus using any of a variety of bus architectures. The memory 504 may be one or more devices for storing data and/or computer code for completing or facilitating methods described herein. The memory 504 may include database components, object code components, script components, or other types of information structure for supporting the various activities herein. Any distributed or local memory device may be utilized with the systems and methods of this description. The memory 504 may be communicably connected to the processing circuitry 502 (e.g., via a circuit or any other wired, wireless, or network connection) and may include computer code for executing one or more processes described herein. The memory 504 may include non-volatile memory 508 (e.g., read-only memory (ROM), erasable programmable read-only memory (EPROM), electrically erasable programmable read-only memory (EEPROM), etc.), and volatile memory 510 (e.g., random-access memory (RAM)), or any other medium which can be used to carry or store desired program code in the form of machine-executable instructions or data structures and which can be accessed by a computer or other machine with processing circuitry 502. A basic input/output system (BIOS) 512 may be stored in the non-volatile memory 508 and can include the basic routines that help to transfer information between elements within the computer system 500.

The computer system 500 may further include or be coupled to a non-transitory computer-readable storage medium such as the storage device 514, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 514 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 514 and/or in the volatile memory 510, which may include an operating system 516 and/or one or more program modules 518. All or a portion of the examples disclosed herein may be implemented as a computer program 520 stored on a transitory or non-transitory computer-usable or computer-readable storage medium (e.g., single medium or multiple media), such as the storage device 514, which includes complex programming instructions (e.g., complex computer-readable program code) to cause the processing circuitry 502 to carry out actions described herein. Thus, the computer-readable program code of the computer program 520 can comprise software instructions for implementing the functionality of the examples described herein when executed by the processing circuitry 502. In some examples, the storage device 514 may be a computer program product (e.g., readable storage medium) storing the computer program 520 thereon, where at least a portion of a computer program 520 may be loadable (e.g., into a processor) for implementing the functionality of the examples described herein when executed by the processing circuitry 502. The processing circuitry 502 may serve as a controller or control system for the computer system 500 that is to implement the functionality described herein.

The computer system 500 may include an input device interface 522 configured to receive input and selections to be communicated to the computer system 500 when executing instructions, such as from a keyboard, mouse, touch-sensitive surface, etc. Such input devices may be connected to the processing circuitry 502 through the input device interface 522 coupled to the system bus 506 but can be connected through other interfaces, such as a parallel port, an Institute of Electrical and Electronic Engineers (IEEE) 1394 serial port, a Universal Serial Bus (USB) port, an IR interface, and the like. The computer system 500 may include an output device interface 524 configured to forward output, such as to a display, a video display unit (e.g., a liquid crystal display (LCD) or a cathode ray tube (CRT)). The computer system 500 may include a communications interface 526 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software.

Although a specific order of method actions may be shown or described, the order of the actions may differ. In addition, two or more actions may be performed concurrently or with partial concurrence.

According to certain examples, there is also disclosed:

Example 1: A computer system (140, 160, 310, 500) for reducing rotational speed of at least one wheel (110) of a vehicle (100), the computer system (140, 160, 310, 500) comprising processing circuitry (150, 170, 315, 502) configured to: determine a first value of rotational kinetic energy (E₁) of one or more powertrain components (110, 120, 210, 220, 230, 240, 250, 260, 320) of the vehicle (100), when the at least one wheel (110) is rotating at a current rotational speed (ω₁); acquire a second value of rotational kinetic energy (E₂) of the one or more powertrain components (110, 120, 210, 220, 230, 240, 250, 260, 320), when the at least one wheel (110) is rotating at a rotational speed (ω₂) where the wheel (110) has traction and/or a desired amount of slip; determine an energy difference (ΔE) between the first value of rotational kinetic energy (E₁) and the second value of rotational kinetic energy (E₂); determine a first retardation torque pulse corresponding to the determined energy difference (ΔE); and cause the determined first retardation torque pulse to be applied to at least one of the one or more powertrain components (110, 120, 210, 220, 230, 240, 250, 260, 320) to reduce the rotational speed of the at least one wheel (110).

Example 2: The computer system (140, 160, 310, 500) of example 1, wherein the processing circuitry (150, 170, 315, 502) is configured to determine the first value of rotational kinetic energy (E₁) based on a respective moment of inertia (Iᵢ) of the one or more powertrain components (110, 120, 210, 220, 230, 240, 250, 260, 320) and a respective current rotational speed (ω₁₁) of the one or more powertrain components (110, 120, 210, 220, 230, 240, 250, 260, 320).

Example 3: The computer system (140, 160, 310, 500) of example 1 or 2, wherein the second value of rotational kinetic energy (E₂) is pre-determined based on a respective moment of moment of inertia (Iᵢ) of the one or more powertrain components (110, 120, 210, 220, 230, 240, 250, 260, 320) and a respective rotational speed (ω₂i) of the one or more powertrain components, when the at least one wheel (110) has traction and/or the desired amount of slip.

Example 4: The computer system (140, 160, 310, 500) of any preceding example, wherein the first retardation torque pulse is a torque applied during a time t in a direction opposite to the direction of rotation of the one or more powertrain components (110, 120, 210, 220, 230, 240, 250, 260, 320).

Example 5: The computer system (140, 160, 310, 500) of any preceding example, wherein the processing circuitry (150, 170, 315, 502) is configured to cause the first retardation torque pulse to be applied to at least one electric motor (120, 210, 320) of the vehicle powertrain components (110, 120, 210, 220, 230, 240, 250, 260, 320).

Example 6: The computer system (140, 160, 310, 500) of example 5, wherein the processing circuitry (150, 170, 315, 502) is further configured to control the at least one electric motor (120, 210, 320) to convert the retardation torque pulse into electric energy and store the electric energy in a battery of the vehicle (100).

Example 7: The computer system (140, 160, 310, 500) of example 5-6, wherein at least two wheels (110a, 110b) of the vehicle (100) are controlled by one electric motor (210) and the processing circuitry (150, 170, 315, 502) is configured to determine the first value of rotational kinetic energy (E₁) for a wheel of the at least two wheels (110a, 110b) rotating with the highest rotational speed and to cause the determined first retardation torque pulse to be applied to the electric motor (210) such that the rotational speed of each of the at least two wheels (110a, 110b) is reduced.

Example 8: The computer system (140, 160, 310, 500) of example 7, wherein the first and second value of rotational kinetic energy each further comprises the rotational kinetic energy of one or more of the one electric motor (210), an input shaft (220), a gearbox (230), an output shaft (240), a differential (250), and an axle shaft (260).

Example 9: The computer system (140, 160, 310, 500) of example 5 or 6, wherein each wheel (110) of the vehicle (100) is controlled by a respective electric wheel motor (320) and the processing circuitry (150, 170, 315, 502) is configured to determine a respective first value of rotational kinetic energy (E₁) for each wheel (110), determine a respective energy difference (ΔE) between the first value of rotational kinetic energy (E₁) and the second value of rotational kinetic energy (E₂); determine a respective first retardation torque pulse corresponding to the determined respective energy difference (ΔE); and cause a respective first retardation torque pulse to be applied to the respective wheel motor (320) such that the rotational speed of each wheel (110) is reduced individually.

Example 10: The computer system (140, 160, 310, 500) of example 9, wherein the first and second value of rotational kinetic energy each further comprises the rotational kinetic energy of the corresponding electric wheel motor (320).

Example 11: The computer system (140, 160, 310, 500) of any preceding example, wherein the processing circuitry (150, 170, 315, 502) is configured to determine the first retardation torque pulse in response to determining that the current rotational speed (ω₁) is above the rotational speed (ω₂) where the wheel (110) has traction and/or the desired amount of slip.

Example 12: The computer system (140, 160, 310, 500) of example 11, wherein the processing circuitry (150, 170, 315, 502) is further configured to determine a second retardation torque pulse to further reduce the wheel speed to the rotational speed (ω₂) where the wheel (110) has traction and/or the desired amount of slip, in response to determining that the rotational speed of the at least one wheel (110) is above the rotational speed (ω₂) where the wheel (110) has traction and/or the desired amount of slip after the first retardation torque pulse has been applied.

Example 13: A vehicle (100) comprising the computer system (140, 160, 310, 500) of any preceding example.

Example 14: A computer implemented method (400) for reducing rotational speed of at least one wheel (110) of a vehicle (100), the method (400) comprising: determining (402), by processing circuitry (150, 170, 315, 502) of a computer system (140, 160, 310, 500), a first value of rotational kinetic energy (E₁) of one or more powertrain components (110, 120, 210, 220, 230, 240, 250, 260, 320) of the vehicle (100) when the at least one wheel (110) is rotating at a current rotational speed (ω₁); acquiring (404), by the processing circuitry (150, 170, 315, 502), a second value of rotational kinetic energy (E₂) of the one or more powertrain components (110, 120, 210, 220, 230, 240, 250, 260, 320), when the at least one wheel (110) is rotating at a rotational speed (ω₂) where the wheel (110) has traction and/or a desired amount of slip; determining (406), by the processing circuitry (150, 170, 315, 502), an energy difference (ΔE) between the first value of rotational kinetic energy (E₁) and the second value of rotational kinetic energy (E₂); determining (408), by the processing circuitry (150, 170, 315, 502) a first retardation torque pulse corresponding to the determined energy difference (ΔE); and causing (410), by the processing circuitry (150, 170, 315, 502), the determined first retardation torque pulse to be applied to at least one of the one or more powertrain components (110, 120, 210, 220, 230, 240, 250, 260, 320) to reduce the rotational speed of the at least one wheel (110).

Example 15: The computer implemented method (400) of example 14, wherein the method comprises determining, by the processing circuitry (150, 170, 315, 502), the first value of rotational kinetic energy (E₁) based on a respective moment of inertia (Iᵢ) of the one or more powertrain components (110, 120, 210, 220, 230, 240, 250, 260, 320) and a respective current rotational speed (ω₁i) of the one or more powertrain components (110, 120, 210, 220, 230, 240, 250, 260, 320).

Example 16: The computer implemented method (400) of example 14 or 15, wherein the method comprises pre-determining, by the processing circuitry (150, 170, 315, 502), the second value of rotational kinetic energy (E₂) based on a respective moment of inertia (Iᵢ) of the one or more powertrain components (110, 120, 210, 220, 230, 240, 250, 260, 320) and a respective rotational speed (ω₂i) of the one or more powertrain components (110, 120, 210, 220, 230, 240, 250, 260, 320), when the at least one wheel (110) has traction and/or the desired amount of slip.

Example 17: The computer implemented method (400) of any of examples 14 to 16, wherein the method comprises applying, by the processing circuitry (150, 170, 315, 502), the first retardation torque pulse during a time t in a direction opposite to the direction of rotation of the one or more powertrain components (110, 120, 210, 220, 230, 240, 250, 260, 320).

Example 18: The computer implemented method (400) of any of examples 14 to 17, wherein the method comprises causing, by the processing circuitry (150, 170, 315, 502), the first retardation torque pulse to be applied to at least one electric motor (120, 210, 320) of the vehicle powertrain components (110, 120, 210, 220, 230, 240, 250, 260, 320).

Example 19: The computer implemented method (400) of example 18, wherein the method further comprises controlling, by the processing circuitry (150, 170, 315, 502), the at least one electric motor (120, 210, 320) to convert the retardation torque pulse into electric energy and store the electric energy in a battery of the vehicle (100).

Example 20: The computer implemented method (400) of example 18 or 19, wherein at least two wheels (110a, 110b) of the vehicle (100) are controlled by one electric motor (210), and the method comprises determining, by the processing circuitry (150, 170, 315, 502), the first value of rotational kinetic energy (E₁) for a wheel of the at least two wheels (110a, 110b) rotating with the highest rotational speed, and causing, by the processing circuitry (150, 170, 315, 502), the determined first retardation torque pulse to be applied to the electric motor (210) such that the rotational speed of each of the at least two wheels (110a, 110b) is reduced.

Example 21: The computer implemented method (400) of example 20, wherein the first and second value of rotational kinetic energy each further comprises the rotational kinetic energy of one or more of the one electric motor (210), an input shaft (220), a gearbox (230), an output shaft (240), a differential (250), and an axle shaft (260).

Example 22: The computer implemented method (400) of example 18 or 19, wherein each wheel (110) of the vehicle (100) is controlled by a respective electric wheel motor (320) and the method comprises determining, by the processing circuitry (150, 170, 315, 502), a respective first value of rotational kinetic energy (E₁) for each wheel (110), a respective energy difference (ΔE) between the first value of rotational kinetic energy (E₁) and the second value of rotational kinetic energy (E₂); a respective first retardation torque pulse corresponding to the determined respective energy difference (ΔE); and causing, by the processing circuitry (150, 170, 315, 502), a respective first retardation pulse to be applied to the respective wheel motor (320) such that the rotational speed of each wheel (110) is reduced individually.

Example 23: The computer implemented method (400) of example 22, wherein the first and second value of rotational kinetic energy each further comprises the rotational kinetic energy of the corresponding electric wheel motor (320).

Example 24: The computer implemented method (400) of any of examples 14 to 23, wherein the method comprises determining, by the processing circuitry (150, 170, 315, 502), the first retardation torque pulse in response to determining that the current rotational speed (ω₁) is above the rotational speed (ω₂) where the wheel (110) has traction and/or the desired amount of slip.

Example 25: The computer implemented method (400) of example 24, wherein the method comprises determining, by the processing circuitry (150, 170, 315, 502), a second retardation torque pulse to further reduce the wheel speed to the rotational speed (ω₂) where the wheel (110) has traction and/or the desired amount of slip, in response to determining that the rotational speed of the at least one wheel (110) is above the rotational speed (ω₂) where the wheel (110) has traction and/or the desired amount of slip after the first retardation torque pulse has been applied.

Example 26: A computer program product comprising program code for performing, when executed by processing circuitry (150, 170, 315, 502), the computer-implemented method (400) of any of examples 14 to 25.

Example 27: A non-transitory computer-readable storage medium comprising instructions, which when executed by processing circuitry (150, 170, 315, 502), cause the processing circuitry to perform the computer-implemented method (400) of any of examples 14 to 25.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system for reducing rotational speed of at least one wheel of a vehicle, the computer system comprising processing circuitry configured to:
determine a first value of rotational kinetic energy of one or more powertrain components of the vehicle when the at least one wheel is rotating at a current rotational speed;
acquire a second value of rotational kinetic energy of the one or more powertrain components when the at least one wheel is rotating at a rotational speed where the wheel has a desired amount of slip;
determine an energy difference between the first value of rotational kinetic energy and the second value of rotational kinetic energy;
determine a first retardation torque pulse corresponding to the determined energy difference; and
cause the determined first retardation torque pulse to be applied to at least one of the one or more powertrain components to reduce the rotational speed of the at least one wheel.

2. The computer system of claim 1, wherein the processing circuitry is configured to determine the first value of rotational kinetic energy based on a respective moment of inertia of the one or more powertrain components and a respective current rotational speed of the one or more powertrain components.

3. The computer system of claim 1, wherein the second value of rotational kinetic energy is pre-determined based on a respective moment of inertia of the one or more powertrain components and a respective rotational speed of the one or more powertrain components when the at least one wheel has the desired amount of slip.

4. The computer system of claim 1, wherein the first retardation torque pulse is a torque applied during a time in a direction opposite to the direction of rotation of the one or more powertrain components.

5. The computer system of claim 1, wherein the processing circuitry is configured to cause the first retardation torque pulse to be applied to at least one electric motor of the vehicle powertrain components.

6. The computer system of claim 5, wherein the processing circuitry is further configured to control the at least one electric motor to convert the retardation torque pulse into electric energy and store the electric energy in a battery of the vehicle.

7. The computer system of claim 5, wherein at least two wheels of the vehicle are controlled by one electric motor and the processing circuitry is configured to:
determine the first value of rotational kinetic energy for a wheel of the at least two wheels rotating with the highest rotational speed; and
cause the determined first retardation torque pulse to be applied to the electric motor such that the rotational speed of each of the at least two wheels is reduced.

8. The computer system of claim 7, wherein the first and second value of rotational kinetic energy each further comprises the rotational kinetic energy of one or more of the one electric motor, an input shaft, a gearbox, an output shaft, a differential, and an axle shaft.

9. The computer system of claim 5, wherein each wheel of the vehicle is controlled by a respective electric wheel motor and the processing circuitry is configured to:
determine a respective first value of rotational kinetic energy for each wheel;
determine a respective energy difference between each first value of rotational kinetic energy and the second value of rotational kinetic energy;
determine a respective first retardation torque pulse corresponding to each determined respective energy difference; and
cause a respective first retardation pulse to be applied to each respective wheel motor such that the rotational speed of each wheel is reduced individually.

10. The computer system of claim 9, wherein the first and second value of rotational kinetic energy each further comprises the rotational kinetic energy of the corresponding electric wheel motor.

11. The computer system of claim 1, wherein the processing circuitry is configured to determine the first retardation torque pulse in response to determining that the current rotational speed is above the rotational speed where the wheel has the desired amount of slip.

12. The computer system of claim 11, wherein the processing circuitry is further configured to determine a second retardation torque pulse to further reduce the wheel speed to the rotational speed where the wheel has the desired amount of slip, in response to determining that the rotational speed of the at least one wheel is above the rotational speed where the wheel has the desired amount of slip after the first retardation torque pulse has been applied.

13. A vehicle comprising the computer system of claim 1.

14. A computer-implemented method for reducing rotational speed of at least one wheel of a vehicle, the method comprising:
determining, by processing circuitry of a computer system, a first value of rotational kinetic energy of one or more powertrain components of the vehicle when the at least one wheel is rotating at a current rotational speed;
acquiring, by the processing circuitry, a second value of rotational kinetic energy of the one or more powertrain components when the at least one wheel is rotating at a rotational speed where the wheel has a desired amount of slip;
determining, by the processing circuitry, an energy difference between the first value of rotational kinetic energy and the second value of rotational kinetic energy;
determining, by the processing circuitry, a first retardation torque pulse corresponding to the determined energy difference; and
causing, by the processing circuitry, the determined first retardation torque pulse to be applied to at least one of the one or more powertrain components to reduce the rotational speed of the at least one wheel.

15. The computer implemented method of claim 14, wherein the method comprises determining, by the processing circuitry, the first value of rotational kinetic energy based on a respective moment of inertia of the one or more powertrain components and a respective current rotational speed of the one or more powertrain components.

16. The computer implemented method of claim 14, wherein the method comprises pre-determining, by the processing circuitry, the second value of rotational kinetic energy based on a respective moment of inertia of the one or more powertrain components and a respective rotational speed of the one or more powertrain components, when the at least one wheel has the desired amount of slip.

17. The computer implemented method of claim 14, wherein the method comprises applying, by the processing circuitry, the first retardation torque pulse during a time t in a direction opposite to the direction of rotation of the one or more powertrain components.

18. The computer implemented method of claim 14, wherein the method comprises causing, by the processing circuitry, the first retardation torque pulse to be applied to at least one electric motor of the vehicle powertrain components.

19. A computer program product comprising program code for performing, when executed by processing circuitry, the computer-implemented method of claim 14.

20. A non-transitory computer-readable storage medium comprising instructions, which when executed by processing circuitry, cause the processing circuitry to perform the computer-implemented method of claim 14.
